(19) United States
(12) Patent Application Publication
(10) Pub. No.: US 2018/0036900 A1
(43) Pub. Date: Feb. 8, 2018

(54) ARBORS FOR CIRCULAR SAWS AND ASSOCIATED SYSTEMS AND METHODS

(71) Applicant: Cuz-D Manufacturing, Inc., dba Cuzdey R&D, Tacoma, WA (US)

(72) Inventor: Jacob Cuzdey, Lacey, WA (US)

(21) Appl. No.: 15/667,495

(22) Filed: Aug. 2, 2017

Related U.S. Application Data
(60) Provisional application No. 62/370,104, filed on Aug. 2, 2016.

(51) Int. Cl. B27B 5/32; B23D 61/02

(52) U.S. Cl. CPC B27B 5/32; B23D 61/025

(57) ABSTRACT

Arbors for circular saws and associated systems and methods are disclosed herein. In one embodiment, an arbor includes a coupler and a flange. The coupler can include an interior mounting face and an engagement feature, and the engagement feature can be shaped to extend through an opening in a saw blade. The flange can include an exterior mounting face and a recess, and the recess can be shaped to at least partially receive the engagement feature. The interior mounting face and the exterior mounting face can be configured to clamp the saw blade therebetween to mount the saw blade to a drive shaft of the circular saw.

### CROSS-REFERENCE TO RELATED APPLICATION(S)

This application claims priority to U.S. Provisional Patent Application No. 62/370,104, entitled “ARBORS FOR CIRCULAR SAWS AND ASSOCIATED SYSTEMS AND METHODS,” filed Aug. 2, 2016, which is incorporated herein by reference in its entirety.

### TECHNICAL FIELD

The following disclosure relates generally to arbors for circular saws and, more particularly, to arbors for securely attaching saw blades to drive shafts of circular saws and associated systems and methods.

### BACKGROUND

A variety of existing circular saws include a motor-driven, rotatable drive shaft. Typically, a saw blade is removably coupled to the drive shaft via an arbor. The arbor is generally a two-piece device that includes an interior portion and an exterior portion. The interior and exterior portions are positioned on opposite sides of a central hole in the saw blade, with the interior portion positioned between the saw blade and a body of the saw. A bolt can be extended through the exterior and interior portions of the arbor and the central hole in the saw blade, and threaded into the drive shaft to secure the saw blade to the drive shaft. A friction fit or a shaped opening (e.g., a knockout opening) is typically used to reduce slippage between the saw blade and the drive shaft. With a friction fit, the bolt is tightened to drive the interior and exterior portions of the arbor towards each other and press against the blade positioned therebetween. If the bolt is insufficiently tightened and/or if the blade is subjected to significant drag forces, the blade can slip with respect to the drive shaft and the arbor. Slippage of the blade can interrupt cutting operations and/or produce inaccurate or otherwise defective cuts.

With knockout openings, the interior portion of the arbor includes an engagement feature that is positionable within a complimentary-shaped knockout opening in the saw blade. The engagement feature and the knockout opening often have complimentary diamond shapes, and the engagement feature extends outwardly, away from the drive shaft, and into the knockout opening to engage the blade. The engagement feature is generally designed to extend outwardly a distance that is less than or equal to the thickness of the saw blade. The bolt can then drive the interior and exterior portions of the arbor toward each other and against the blade, without the engagement feature contacting the exterior portion and preventing the interior portion and exterior portion from securely contacting the blade. In most cases, the diamond shaped engagement feature and the corresponding knockout opening can help reduce slippage between the blade and the drive shaft. Slippage can still occur, however, if the engagement feature does not stay positively engaged within the blade via the knockout opening. If a relatively thick saw blade is used, for example, the engagement feature may not extend a significant enough depth into the knockout opening. Excessive forces on the blade and/or insufficient tightening of the bolt can then result in movement of the blade that disengages the engagement feature from the knockout opening and results in blade slippage.

### BRIEF DESCRIPTION OF THE DRAWINGS

FIGS. 1A and 1B are isometric front and rear views, respectively, of an arbor configured in accordance with an embodiment of the present technology.

FIG. 2A is an isometric front view of an arbor coupler configured in accordance with an embodiment of the present technology, and FIG. 2B is an isometric rear view of an arbor flange configured in accordance with an embodiment of the present technology.

FIG. 3 is an exploded isometric view of an arbor positioned for engagement with a saw blade in accordance with an embodiment of the present technology.

FIG. 4 is a cross-sectional overhead view of an arbor engaged with a saw blade in accordance with an embodiment of the present technology.

FIG. 5A is an isometric view of a circular saw blade mounted to a saw in accordance with an embodiment of the present technology, and FIG. 5B is an exploded isometric view illustrating installation of a circular saw blade on a circular saw via an arbor configured in accordance with an embodiment of the present technology.

### DETAILED DESCRIPTION

The following disclosure describes various embodiments of arbors for circular saws and associated systems and methods. In several embodiments, an arbor includes a coupler and a flange. The coupler can include an interior mounting face and an engagement feature, and the engagement feature can be shaped to extend through an opening in a saw blade. The flange can include an exterior mounting face and a recess, and the recess can be shaped to at least partially receive the engagement feature. The flange and the coupler can be configured to fixedly attach the saw blade to a drive shaft of the circular saw, with the saw blade clamped at least partially between the interior mounting face and the exterior mounting face.

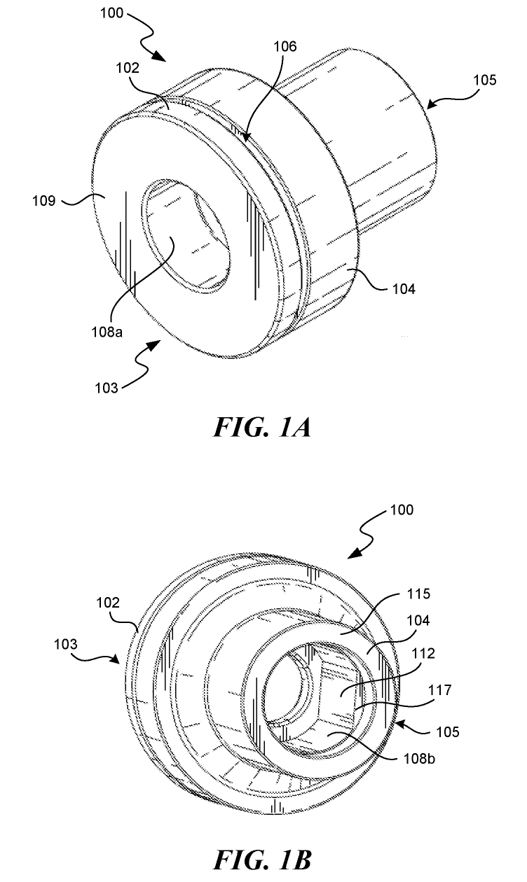

In other embodiments, the arbors described herein and the associated devices, systems and methods can have different configurations, components, and/or procedures. Still other embodiments may eliminate particular features, components and/or procedures. A person of ordinary skill in the relevant art, therefore, will understand that the present technology, which includes associated devices, systems, and procedures, may include other embodiments with additional elements or steps, and/or may include other embodiments without several of the features or steps shown and described below with reference to FIGS. 1-5B.

As discussed above, existing arbors may not adequately prevent slippage of a saw blade relative to a corresponding drive shaft. The present technology includes several embodiments of arbors and associated systems and methods that have engagement features for significantly reducing or even preventing the opportunity for slippage between a saw blade and the arbor. In some embodiments, such arbors can be referred to as “slipless arbors.” As used herein, the term “slipless arbors” refers to arbors that prevent or significantly reduce opportunities for slippage between an arbor and an associated saw blade. Certain details are set forth in the following description and FIGS. 1-5B to provide a thorough understanding of various embodiments of the disclosure. To avoid unnecessarily obscuring the description of the various embodiments of the disclosure, other details describing well-known structures and systems often associated with arbors, circular saw blades, circular saws, and the components or devices associated with the manufacture of conventional arbors, circular saw blades and circular saws are not set forth below. Moreover, many of the details and features shown in the Figures are merely illustrative of particular embodiments of the disclosure. Accordingly, other embodiments can have other details and features without departing from the spirit and scope of the present disclosure. In addition, the various elements and features illustrated in the Figures may not be drawn to scale. Furthermore, various embodiments of the disclosure can include structures other than those illustrated in the Figures and are expressly not limited to the structures shown in the Figures.

In the Figures, identical reference numbers identify identical, or at least generally similar, elements. To facilitate the discussion of any particular element, the most significant digit or digits of any reference number refers to the Figure in which that element is first introduced. For example, element 102 is first introduced and discussed with reference to FIG. 1A.

FIG. 1A is an isometric front view of an arbor 100 configured in accordance with an embodiment of the present technology. In the illustrated embodiment, for example, the arbor 100 includes an exterior portion or flange 102 positioned toward a distal end 103 and an interior portion or coupler 104 positioned toward a proximal end 105. When the flange 102 and the coupler 104 are mated as shown in FIG. 1A, an annular gap 106 exists between the flange 102 and the coupler 104. As described in more detail below, the gap 106 is configured to receive a portion of a saw blade to secure the blade to a drive shaft.

FIG. 1B is an isometric rear view of the arbor 100 of FIG. 1A. Referring to FIGS. 1A and 1B together, the arbor flange 102 includes a flange bore 108a and an exterior face 109, and the arbor coupler 104 includes a coaxial coupler bore 108b. The flange bore 108a and the coupler bore 108b are identified collectively as the arbor bore 108. As further described below, a bolt can extend through the bore 108 to secure a saw blade to a drive shaft of a circular saw via the arbor 100.

In the illustrated embodiment, the coupler bore 108b includes two opposing flat surfaces 112 (only one flat surface 112 visible in FIG. 1B). The coupler bore 108b can be sized and shaped so that the flat surfaces 112 securely contact complimentary flat surfaces on the drive shaft to prevent rotation of the coupler 104 with respect to the drive shaft. The coupler 104 also includes an interior face 115 at the proximal end 105, and a shoulder 117 within the coupler bore 108b. The shoulder 117 can be positioned to abut a corresponding shoulder on the drive shaft of the circular saw.

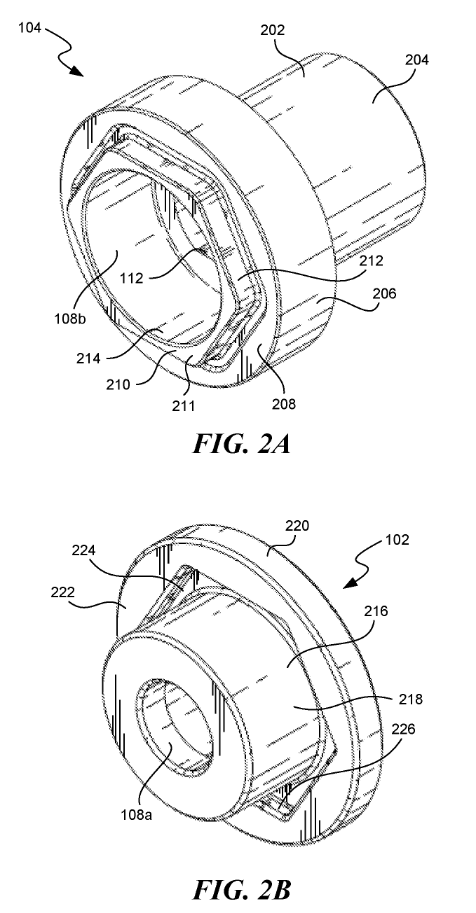

FIG. 2A is an isometric front view of the coupler 104 configured in accordance with an embodiment of the present technology. In the illustrated embodiment, the coupler 104 includes a body 202 having a cylindrical portion 204 and an annular portion 206. The coupler bore 108b extends through the cylindrical portion 204 and the annular portion 206, with the flat surfaces 112 extending within the cylindrical portion 204. The annular portion 206 includes an interior mounting face 208 and an engagement feature 210. The engagement feature 210 extends outwardly, away from the interior mounting face 208. The engagement feature 210 includes a forward face 211, an inner wall 214, and a hexagonal wall 212 having six flat portions.

FIG. 2B is an isometric rear view of the flange 102 configured in accordance with an embodiment of the present technology. In the illustrated embodiment, the flange 102 includes a body 216 having a circular cylindrical portion 218 and a coaxial annular portion 220. In some embodiments, the cylindrical portion 218 is sized and configured for a close-fit with the inner wall 214 of the engagement feature 210. The flange bore 108a extends through the cylindrical portion 218 and the annular portion 220, and the annular portion 220 includes an exterior mounting face 222 and a recess 224. The recess 224 extends into the annular portion 220 adjacent to the cylindrical portion 218 and has a hexagonal shape at least partially defined by a hexagonal outer wall 226 having six flat portions. The recess 224 is shaped to engage the engagement feature 210 and, as described in more detail below, the engagement feature 210 can be at least partially received in the recess 224. Although the engagement feature 210 includes the hexagonal wall 212 and the recess 224 includes the hexagonal outer wall 226, in other embodiments engagement features and corresponding recesses can include other shapes (e.g., oval, star, square, etc.).

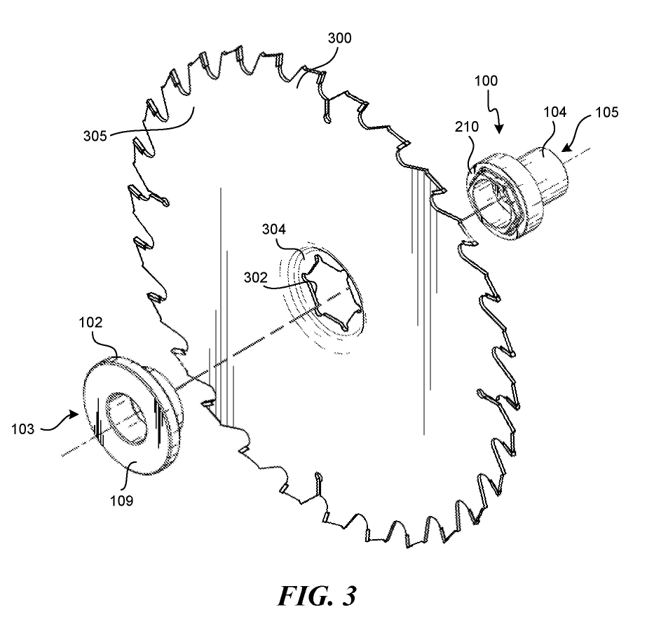

FIG. 3 is an exploded isometric view of the arbor 100 positioned for engagement with a saw blade 300 in accordance with an embodiment of the present technology. In the illustrated embodiment, the saw blade 300 includes a central opening 302 positioned in a cupped central mounting portion 304 and shaped to receive the engagement feature 210. Specifically, the opening 302 has a hexagonal shape that is sized to snugly receive the engagement feature 210. The saw blade 300 also includes an exterior planar surface 305. In the illustrated embodiment, the saw blade 300 can be mounted on the arbor 100 with the exterior face 109 of the flange 102 coplanar with the exterior planar surface 305. In other embodiments, the exterior face 109 can be recessed within the cupped portion 304 (i.e., offset from the exterior planar surface 305 in a direction toward the proximal end 105 of the arbor 100).

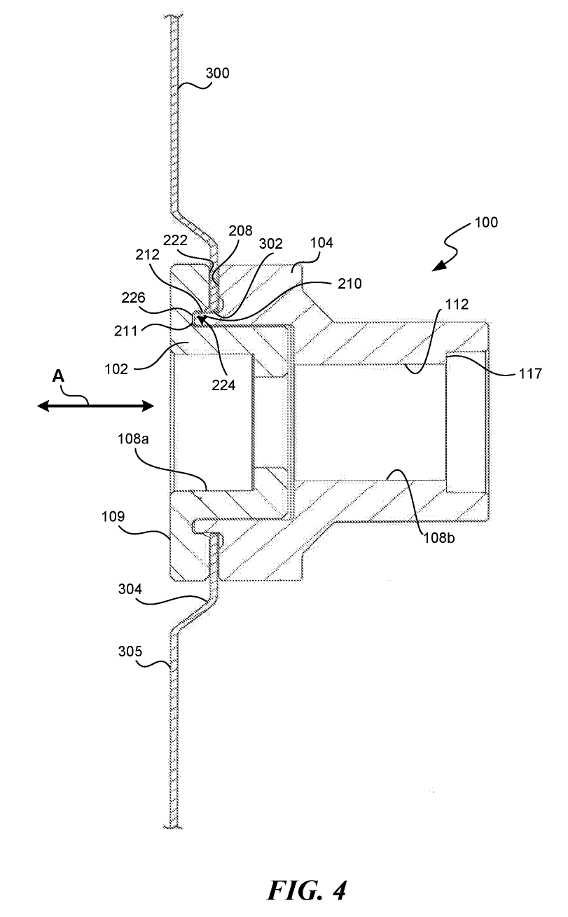

FIG. 4 is a cross-sectional overhead view of the arbor 100 engaged with the saw blade 300 in accordance with an embodiment of the present technology. In the illustrated embodiment, the arbor 100 securely engages the saw blade 300 to reduce or prevent slippage of the blade 300 relative to the arbor 100. In particular, the engagement feature 210 of the coupler 104 extends through the opening 302 in the saw blade 300 and into the recess 224 of the flange 102, “locking” at least a portion of the saw blade 300 between the interior mounting face 208 and the exterior mounting face 222. The hexagonal opening 302 of the saw blade is aligned in a close-fit with the hexagonal wall 212 of the engagement feature 210, preventing rotation of the saw blade 300 with respect to the arbor 100. Additionally, the hexagonal wall 212 of the engagement feature 210 is aligned in a close-fit with the hexagonal outer wall 226 of the flange 102, preventing rotation of the flange 102 with respect to the coupler 104. Moreover, the interior mounting face 208 and the exterior mounting face 222 are driven toward each other by a bolt (not shown in FIG. 4) and clamp the saw blade 300 therebetween.

In the illustrated embodiment, the engagement feature 210 extends past the opening 302 in the saw blade 300, such that the saw blade 300 is axially offset from the forward face 211 of the engagement feature (i.e., offset in a direction along an axial axis A). The axial offset between the saw blade 300 and the forward face 211 of the engagement feature 210 can help to prevent the saw blade 300 from moving off of the engagement feature 210, and thereby significantly reduce the opportunity for slippage between the saw blade 300 and the arbor 100. Specifically, when the saw blade 300 is positioned on the coupler 104 with the engagement feature 210 extending through the hexagonal opening 302, the close fit of the hexagonal opening 302 and the hexagonal wall 212 prevents rotation of the saw blade 300 with respect the arbor 100. Absent deformation of the saw blade 300 or the arbor 100, slippage of the saw blade 300 with respect to the arbor 100 is only possible when the engagement feature 210 moves out of the opening 302. The axial offset of the saw blade 300 and the forward face 211 of the engagement feature 210 reduces undesired movement of the engagement feature 210 out of the opening 302, and thereby reduces the opportunity for slippage. In several embodiments, the axial offset between the saw blade 300 and the forward face 211 of the engagement feature 210 can be at least partially dependent on an axial offset between the forward face 211 and the interior mounting face 208. In some embodiments, the axial offset between the forward face 211 and the interior mounting face 208 can be 3 mm. In other embodiments, the axial offset between the forward face 211 and the interior mounting face 208 can be between 1 mm and 5 mm, or between 1 mm and 30 mm.

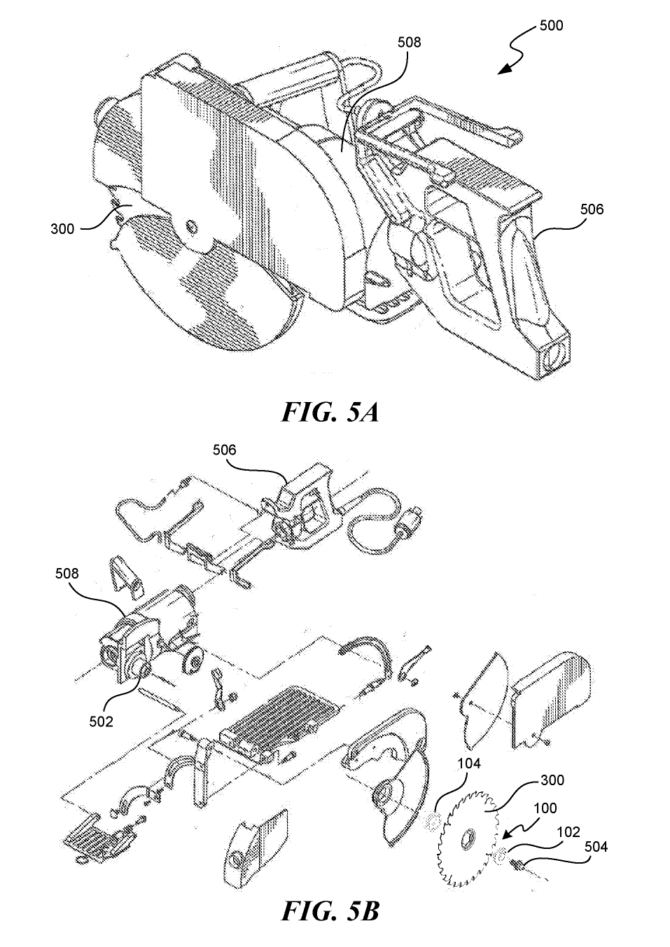

FIG. 5A is an isometric view of the circular saw blade 300 mounted to a saw 500 in accordance with an embodiment of the present technology. In some embodiments, the saw 500 can include one or more handles 506 and a motor assembly 508. The motor assembly 508 is operative to drive the saw blade 300 via a drive shaft 502. FIG. 5B is an exploded isometric view illustrating a method of mounting the saw blade 300 to the circular saw 500 via the arbor 100. In the illustrated embodiment, the saw blade 300 is secured to the drive shaft 502 of the circular saw 500 via a bolt 504. Specifically, the bolt 504 can extend through the bore 108 (FIGS. 1A-4) of the arbor 100, through the opening 302 in the saw blade 300 (FIGS. 3 and 4), and threadably engage a corresponding threaded hole in the drive shaft 502. The bore 108 can be shaped to receive a head of the bolt 504 so that the head does not extend beyond the exterior face 109 of the flange 102. As noted above, the saw blade 300 can be mounted on the arbor 100 with the exterior face 109 of the flange 102 flush with the exterior planar surface 305, or recessed within the cupped portion 304. In such embodiments, no portion of the arbor 100 or the bolt 504 extends beyond the exterior planar surface 305 of the saw blade 300, and the arbor 100 can provide flush-cut capabilities for associated circular saws. For example, the arbor 100 can mount the saw blade 300 such that no portion of the associated saw or any other component extends beyond the exterior planar surface 305. When mounted in such a manner, the associated saw can cut along a cutting path that is directly adjacent to a planar surface. In several embodiments, the arbor 100 can provide flush-cut capabilities for saws that are at least generally similar to those described in U.S. patent application Ser. No. 13/817,765, filed Aug. 18, 2011, which is incorporated herein by reference in its entirety.

In addition to eliminating or significantly reducing slippage and providing flush-cut capabilities, arbors configured in accordance with the present technology are expected to reduce or eliminate saw path deflection during cutting operations. When a force is applied to a conventional circular saw to advance the saw along a cutting path, the saw will tend to stray or deflect away from the direction of the force at a slight angle, and thereby deviate from the intended cutting path. Without being bound by any theory or mechanism of action, the inventor believes that the arbor 100 can include dimensions that help to reduce or eliminate such saw path deflection. More particularly, the arbor 100 can be constructed with the gap 106 (FIG. 1) positioned to align the blade 300 in a cutting plane that reduces saw path deflection. It is believed that the location of the cutting plane that produces the minimum saw path deflection can depend on one or more features of the circular saw or its associated components. For example, it is believed that the axis of rotation of a motor on the circular saw can influence the proper positioning of the cutting plane for reduced saw path deflection.

The inventor has determined that particular dimensions of the arbor 100 can position the saw blade 300 at a location that significantly reduces or eliminates saw path deflection. For example, in one embodiment, an axial distance from the shoulder 117 of the coupler 104 to the interior mounting face 208 can be between 20 mm and 35 mm, or about 27.5 mm. The inventor has determined that for particular circular saws, an axial offset of 27.5 mm between the shoulder 117 and the interior mounting face 208 significantly reduces saw path deflection. In other embodiments, the distance between the shoulder 117 and the interior mounting face 208 can be larger or smaller than 27.5 mm. For example, the distance between the shoulder 117 and the interior mounting face can be between 5 mm and 100 mm or between 20 mm and 40 mm.

In some embodiments, other dimensions can determine the proper positioning of a blade to reduce or eliminate saw path deflection. For example, in one embodiment, an axial distance between the interior face 115 of the coupler 104 and the interior mounting face 208 can be 32.5 mm to provide significantly reduced saw path deflection. In other embodiments, the distance between the interior face 115 of the coupler 104 and the interior mounting face 208 can be larger or smaller than 32.5 mm (e.g., between 5 mm and 100 mm or between 25 mm and 45 mm).

The arbor 100 and associated components described herein can be constructed using a variety of materials and manufacturing methods known in the art. For example, the arbor 100 can be machined from metal and/or metal alloy stock materials (e.g., steel or aluminum) via a milling machine, a vertical or horizontal machining center, a multi-tasking machine, or other manufacturing machines and/or tools. In some embodiments, the arbor 100 can be cast formed via metal and/or metal alloys. In other embodiments, the arbor 100 can be formed from plastics, composites, metals and/or other materials via a 3D printer or via other manufacturing methods.

The present technology can include a variety of methods for reducing slippage between an arbor and a circular saw blade. A particular method can include forming an arbor having an engagement feature shaped to extend through an opening in a circular saw blade. Forming the arbor can include forming a coupler that includes the engagement feature, and forming a flange having a recess shaped to receive the engagement feature.

From the foregoing, it will be appreciated that specific embodiments have been described herein for purposes of illustration, but that various modifications may be made without deviating from the spirit and scope of the present technology. Those skilled in the art will recognize that numerous modifications or alterations can be made to the components or systems disclosed herein. For example, an embodiment described above included an interior portion or coupler having an engagement feature, and an exterior portion or flange having a recess. In other embodiments, an interior portion or coupler can include a recess and an exterior portion or flange can include an engagement feature shaped to be at least partially received in the recess of the coupler. Moreover, certain aspects of the present technology described in the context of particular embodiments may be combined or eliminated in other embodiments. Furthermore, while advantages associated with certain embodiments have been described in the context of those embodiments, other embodiments may also exhibit such advantages, and not all embodiments need necessarily exhibit such advantages to fall within the scope of the present technology. Accordingly, the inventions are not limited except as by the appended claims.

I/We claim:

1. An arbor for a circular saw, comprising:
a coupler having an interior mounting face and an engagement feature, wherein the engagement feature is shaped to extend through an opening in a saw blade; and
a flange having an exterior mounting face and a recess,
wherein the recess is shaped to at least partially receive the engagement feature, and
wherein the interior mounting face and the exterior mounting face are configured to clamp the saw blade therebetween to mount the saw blade to a drive shaft of the circular saw.

2. The arbor of claim 1 wherein the engagement feature has a hexagonal shape and the recess has a corresponding hexagonal shape configured to engage the engagement feature.

3. The arbor of claim 1 wherein the flange includes a cylindrical portion sized and configured for a close-fit with a corresponding inner wall of the engagement feature.

4. The arbor of claim 1 wherein the coupler includes an interior face spaced from the interior mounting face an axial distance between about 25 mm and about 45 mm.

5. The arbor of claim 1 wherein the flange includes a flange bore and the coupler includes a coaxial coupler bore, and wherein the flange bore and the coupler bore are each configured to receive a bolt therethrough to secure the saw blade to the drive shaft.

6. The arbor of claim 5 wherein the flange bore is configured to receive a head of a bolt whereby the head does not extend beyond an exterior face of the flange.

7. The arbor of claim 5 wherein the coupler bore includes one or more flat surfaces sized and shaped to securely contact complimentary flat surfaces on the drive shaft to prevent rotation of the coupler with respect to the drive shaft.

8. The arbor of claim 5 wherein the coupler includes a shoulder within the coupler bore spaced from the interior mounting face an axial distance between about 20 mm and about 35 mm.

9. A circular saw, comprising:
one or more handles;
a motor assembly;
a drive shaft; and
an arbor, including—
a coupler having an interior mounting face and an engagement feature, wherein the engagement feature is shaped to extend through an opening in a saw blade; and
a flange having an exterior mounting face and a recess, wherein the recess is shaped to at least partially receive the engagement feature, and wherein the interior mounting face and the exterior mounting face are configured to clamp the saw blade therebetween to mount the saw blade to the drive shaft of the circular saw.

10. The circular saw of claim 9 wherein the engagement feature has a hexagonal shape and the recess has a corresponding hexagonal shape configured to engage the engagement feature.

11. The circular saw of claim 9 wherein the flange includes a cylindrical portion sized and configured for a close-fit with a corresponding inner wall of the engagement feature.

12. The circular saw of claim 9 wherein the coupler includes an interior face spaced from the interior mounting face an axial distance between about 25 mm and about 45 mm.

13. The circular saw of claim 9 wherein the flange includes a flange bore and the coupler includes a coaxial coupler bore, the flange bore and the coupler bore each configured to receive a bolt therethrough to secure the saw blade to the drive shaft.

14. The circular saw of claim 13 wherein the coupler bore includes one or more flat surfaces sized and shaped to securely contact complimentary flat surfaces on the drive shaft to prevent rotation of the coupler with respect to the drive shaft.

15. The circular saw of claim 13 wherein the coupler includes a shoulder within the coupler bore spaced from the interior mounting face an axial distance between about 20 mm and about 35 mm.

16. The circular saw of claim 13 wherein the flange bore is configured to receive a head of a bolt whereby the head does not extend beyond an exterior face of the flange.

17. The circular saw of claim 16, further comprising a circular saw blade positioned between the interior mounting face and the exterior mounting face.

18. The circular saw of claim 17 wherein the circular saw blade includes a cupped central mounting portion and an exterior planar surface substantially coplanar with the exterior face of the flange.
